(19) United States
(12) Patent Application Publication
(10) Pub. No.: US 2026/0223778 A1
(43) Pub. Date: Aug. 6, 2026

(54) MOWER DECK AND MOWER

(71) Applicant: KUBOTA CORPORATION, Osaka (JP)

(72) Inventors: Luke LONG, Gainesville, GA (US); Kyle HAYES, Gainesville, GA (US); Kyle MAXWELL, Gainesville, GA (US)

(73) Assignee: KUBOTA CORPORATION, Osaka (JP)

(21) Appl. No.: 19/047,070

(22) Filed: Feb. 6, 2025

(51) Int. Cl. A01D 34/71; A01D 34/00; A01D 34/66; A01D 101/00

(52) U.S. Cl. CPC A01D 34/71; A01D 34/005; A01D 34/667; A01D 2101/00

(57) ABSTRACT

A mower deck mountable on a vehicle includes: a housing including a top wall; a blade below the top wall and rotatable through an area about a vertical axis; and a baffle unit extending downward from the top wall, surrounding the area to define inside a blade rotation space for mulching, and including: a front baffle facing forward-travel side of the vehicle and extending downward from the top wall to have a lower end below an upper end of the blade to prevent cut grass from being discharged from under the lower end; and a rear baffle facing rearward-travel side of the vehicle and extending downward from the top wall to a vertical position that allows cut grass to be discharged from under the lower end, the rear baffle including a cut grass discharge preventer at a peripheral portion of the area to prevent cut grass from being discharged.

### FIELD OF THE INVENTION

The present invention relates to a mower deck and a mower.

### BACKGROUND OF THE INVENTION

A mower deck is mounted on a vehicle, and includes rotary blades to mow grass. US 2021/0274707 A1 discloses a mower deck configured to produce mulch. The mower deck includes a housing and cylindrical baffle units each surrounding the area of the rotation of the corresponding blade. Each baffle unit includes a front baffle and a rear baffle having respective different dimensions from the top plate; that is, the rear baffle has a vertical dimension smaller than that of the front baffle. This configuration forms a passage hole under each rear baffle for discharging cut grass. The mower deck thereby allows cut grass to be partially discharged from a rear portion of the housing through the passage hole.

The mower deck is, however, configured such that the entire rear baffle is vertically shorter than the front baffle. This lets cut grass be discharged rearward over a wide range and unfortunately soils the wheels, the vehicle body, and the like with cut grass over large areas. Further, the rear baffle forms thereunder a passage hole so wide as to disperse air passing through the passage hole and unfortunately weaken the force with which cut grass passes through the passage hole.

The above circumstances have led to a demand for a mower deck and a mower each configured to prevent cut grass from being discharged rearward over a wide range and discharge cut grass with a large force through a passage hole under each rear baffle.

### SUMMARY OF THE INVENTION

A mower deck as an embodiment of the present invention is a mower deck mountable on a vehicle, the mower deck including: a housing including a top wall; a blade disposed below the top wall and rotatable through an area about a vertical axis; and a baffle unit extending downward from the top wall and surrounding the area to define inside a blade rotation space for mulching, the baffle unit including: a front baffle facing a forward-travel side of the vehicle and extending downward from the top wall to have a lower end below an upper end of the blade to prevent cut grass from being discharged from under the lower end; and a rear baffle facing a rearward-travel side of the vehicle and extending downward from the top wall to a vertical position that allows cut grass to be discharged from under a lower end of the rear baffle, the rear baffle including a cut grass discharge preventer disposed at a peripheral portion of the area and configured to prevent cut grass from being discharged.

The above configuration forms a passage hole under the rear baffle for discharging cut grass. The cut grass discharge preventer prevents cut grass from being discharged through a portion of the passage hole. This allows cut grass to be discharged only in a particular direction through the passage hole, and prevents cut grass from being discharged over a wide range.

Further, the cut grass discharge preventer narrows the passage hole to reduce the dispersion of air passing through the passage hole and allow cut grass to be discharged through the passage hole with a large force.

### BRIEF DESCRIPTION OF THE DRAWINGS

The present disclosure is further described in the detail description which follows, in reference to the noted plurality of drawings by way of non-limiting examples of exemplary embodiments of the present disclosure, in which like reference numerals represent similar parts throughout the several views of the drawings, and wherein:

FIG. 1 is a side view of a front mount mower in its entirety with a mower deck.

FIG. 2 is a plan view of a mower deck.

FIG. 3 is a perspective view of a mower deck from below.

FIG. 4 is a perspective view of a blade.

FIG. 5 is a diagram illustrating the configuration of a left subunit.

FIG. 6 is a diagram illustrating the configuration of a central subunit.

FIG. 7 is a diagram illustrating the configuration of a right subunit.

FIG. 8 is a perspective view of a mower deck from below, illustrating airflow inside the mower deck.

FIG. 9 is a side view of a zero-turn mower in its entirety with a mower deck.

### DETAILED DESCRIPTION OF THE INVENTION

The description below deals with an embodiment of the present invention with reference to drawings. Unless otherwise specified, the description below uses terms such as “front” and “forward” to refer to the direction indicated with arrow FW in the drawings, terms such as “back” and “backward” to refer to the direction indicated with arrow BK in the drawings, terms such as “left” and “leftward” to refer to the direction indicated with arrow LH in the drawings, terms such as “right” and “rightward” to refer to the direction indicated with arrow RH in the drawings, terms such as “above” and “upward” to refer to the direction indicated with arrow UP in the drawings, and terms such as “below” and “downward” to refer to the direction indicated with arrow DW in the drawings.

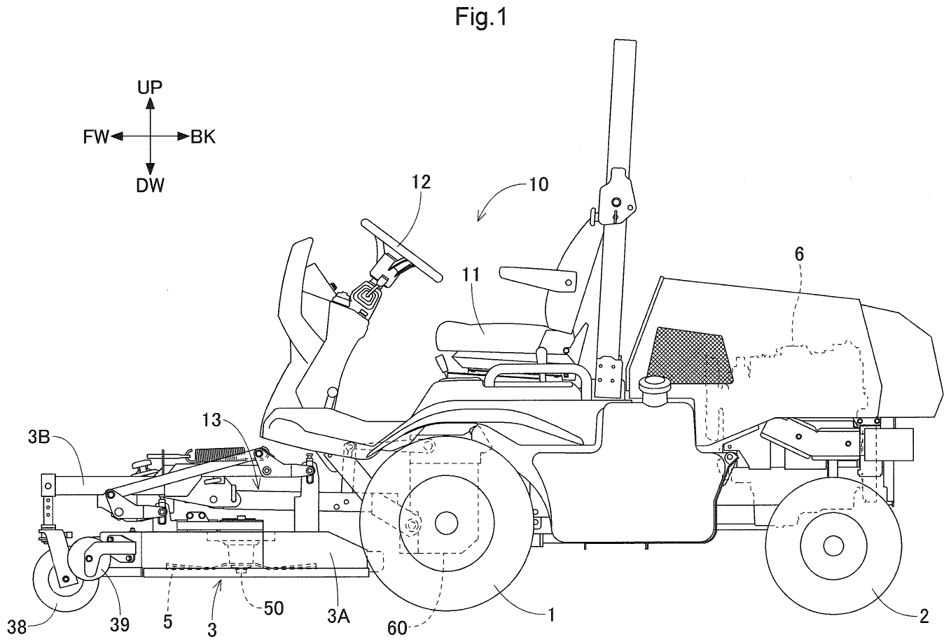

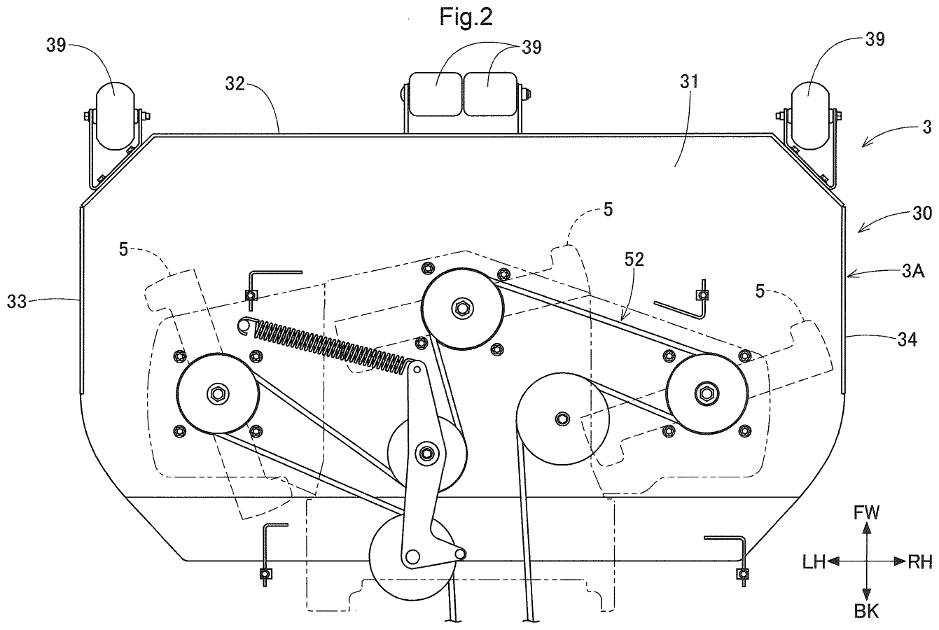

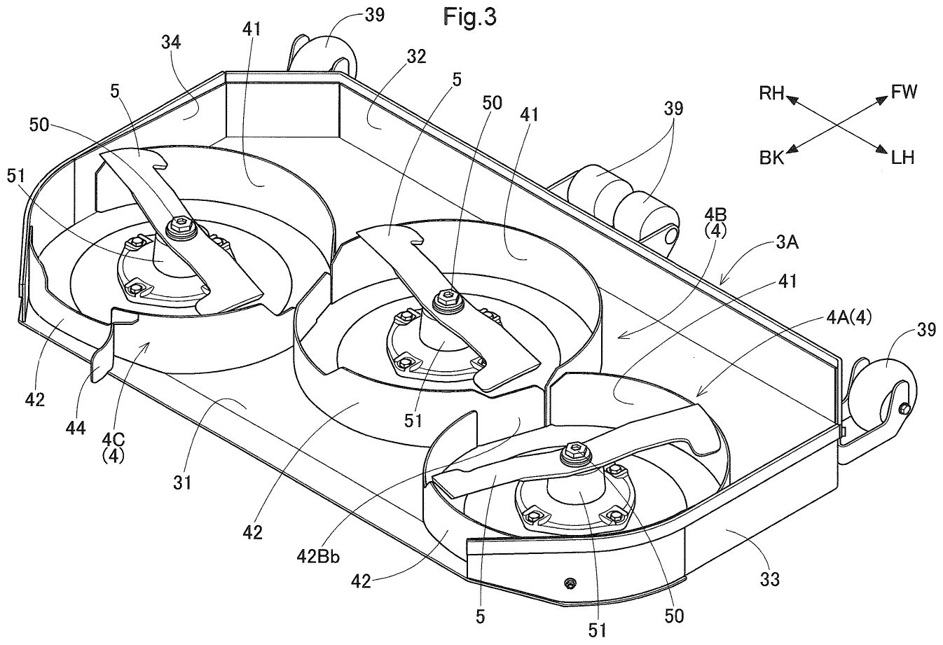

The description below deals with a mower including a mower deck as a specific embodiment of the present invention with reference to drawings. FIG. 1 is a side view of the mower. FIG. 2 is a plan view of the mower deck. FIG. 3 is a perspective view of the mower deck from below.

### Overall Configuration of Mower

The mower includes a vehicle and a mower device 3 forward of the vehicle. The vehicle includes a pair of left and right drivable front wheels 1 and a pair of left and right turnable rear wheels 2. The vehicle includes at a front portion a riding-type driver section 10 including a driver's seat 11 and a steering wheel 12 for use to turn the rear wheels 2. The vehicle includes an engine 6 at a rear portion and a transmission device 60 disposed below the driver section 10 and configured to adjust motive power from the engine 6 and transmit the resulting motive power to the front wheels 1 and the mower device 3. The vehicle is provided with a lifting/lowering link mechanism 13 configured to swing upward and downward by means of a hydraulic cylinder. The mower device 3 is attached to the vehicle with use of the lifting/lowering link mechanism 13 in such a manner as to be capable of being lifted and lowered.

### Mower Device

As illustrated in FIGS. 1 to 3, the mower device 3 includes a mower deck 3A and a support frame 3B. The mower deck 3A includes three laterally arranged blades 5 and a housing 30. The housing 30 includes a top wall 31, a front wall 32 extending downward from the front edge of the top wall 31, a left wall 33 extending downward from the left edge of the top wall 31, and a right wall 34 extending downward from the right edge of the top wall 31. The housing 30 covers the blades 5 from above. The housing 30 is provided with a skid 35 disposed near the center of a rear portion and fixed to the top wall 31. The left and right walls 33 and 34 have respective rear portions so bent as to be closer to each other further rearward.

The support frame 3B is above the top wall 31, and has a first end coupled to the top wall 31 and a second end coupled to the lifting/lowering link mechanism 13. The support frame 3B includes a pair of left and right longitudinal frame members. The mower device 3 includes a pair of left and right ground wheels 38 attached to respective front end portions of the longitudinal frame members and apart from each other by a predetermined distance. The mower device 3 includes four auxiliary wheels 39 each attached to the front wall 32 with a bracket in-between. Two of the auxiliary wheels 39 are at a forward and laterally central portion of the mower deck 3A, and the other two are at respective forward and lateral end portions of the mower deck 3A.

### Blades

As illustrated in FIGS. 2 to 4, the mower device 3 includes three rotary shafts 50 extending vertically relative to the vehicle. The three blades 5 are fixed to respective lower end portions of the rotary shafts 50. The rotary shafts 50 extend through the top wall 31 to be rotatably attached to respective bearings 51 attached to the top wall 31. The rotary shafts 50 are rotatable by a belt-type power transmission mechanism 52 configured to receive motive power from the transmission device 60.

As illustrated in FIG. 3, the mower device 3 includes a baffle unit 4. Each blade 5 rotates through an area defined sideways by the baffle unit 4 and above by the top wall 31 as a blade rotation space for mulching. In other words, the baffle unit 4 and the top wall 31 form a blade rotation space for mulching. The baffle unit 4 is butt-joined to the top wall 31 and extends downward therefrom. The above configuration allows each blade 5 to rotate about a vertical shaft under the top wall 31.

### Baffle Unit

The baffle unit 4 includes a left subunit 4A defining the area of the rotation of the left blade 5, a central subunit 4B defining the area of the rotation of the central blade 5, and a right subunit 4C defining the area of the rotation of the right blade 5. The subunits 4A, 4B, and 4C each include a front baffle 41 facing the forward-travel side of the vehicle and a rear baffle 42 facing the rearward-travel side of the vehicle. The front baffle 41 has a cross section in the shape of a semicircular arc extending along the edge of the front half of the area of the rotation of the corresponding blade 5. The rear baffle 42 has a cross section in the shape of a semicircular arc extending along the edge of the rear half of the area of the rotation of the corresponding blade 5.

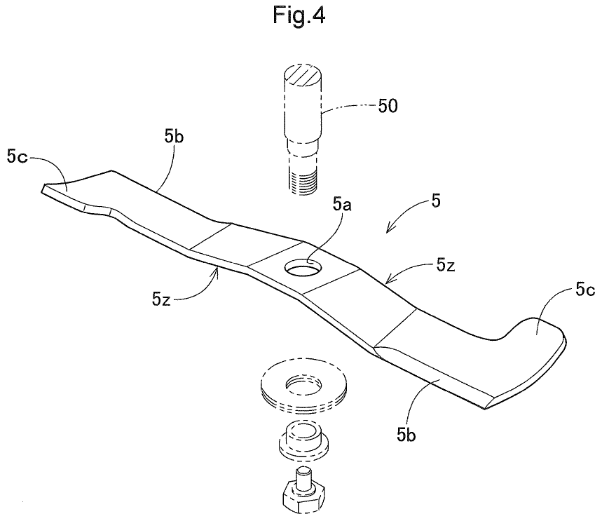

The blades 5 are, as illustrated in FIG. 4, each in the form of a flat plate with a central area having a central hole 5a through which extends the lower end of the corresponding vertical rotary shaft 50. The blades 5 are bolted to the respective rotary shafts 50. The blades 5 are each bent at small angles to include two step portions 5z and extend at two different levels. The blades 5, as attached to the respective rotary shafts 50, each have opposite end portions lower in position than the central portion.

The blades 5 each have two cutting edges 5b each extending from one of the opposite end portions of the blade 5 to the outer side of the corresponding step portion 5z. The blades 5 each include two wind generators 5c each at a corner of an end portion of the blade 5 which corner is opposite to the corresponding cutting edge 5b. The wind generators 5c are each bent upward in the shape of an inverted U.

The blades 5 each rotate through an area defined by the top wall 31 and the corresponding one of the subunits 4A, 4B, and 4C as described above. This allows the mower deck 3A to cut mowed grass multiple times with use of the blades 5 to produce mulch.

### Left Subunit

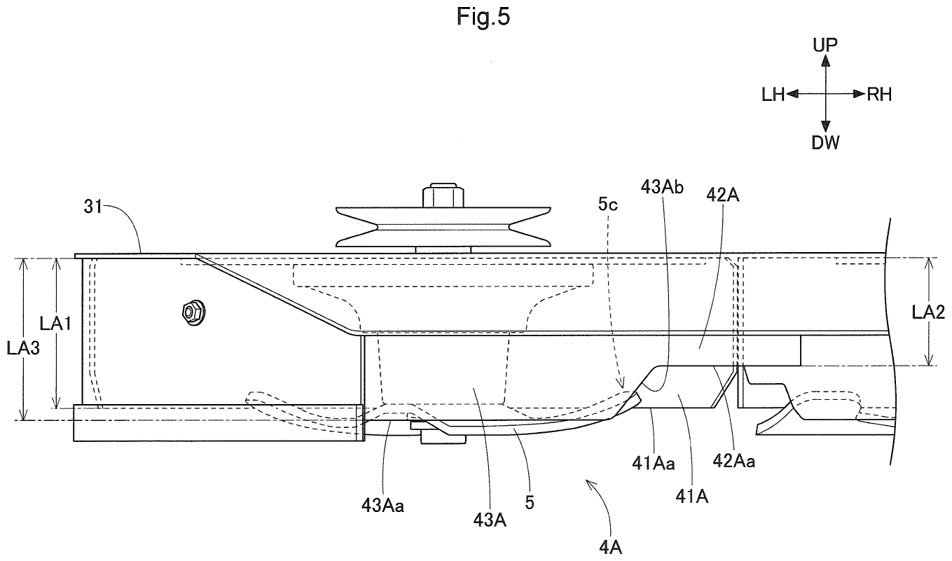

FIG. 5 illustrates the left subunit 4A, which includes a front baffle 41A and a rear baffle 42A. The front baffle 41A extends downward from the top wall 31 to below the upper end of the corresponding blade 5 (or of its wind generators 5c). The front baffle 41A has an upper end joined to the top wall 31 and a lower end 41Aa apart from the upper end by a distance LA1, whereas the rear baffle 42A has an upper end joined to the top wall 31 and a lower end 42Aa apart from the upper end by a distance LA2, the distance LA1 being larger than the distance LA2. The front baffle 41A thus extends downward to have a lower end 41Aa close to the ground surface and thereby prevent cut grass from being discharged from under the lower end 41Aa. The rear baffle 42A, in contrast, extends downward to have a lower end 42Aa that allows cut grass to be discharged from thereunder.

The rear baffle 42A includes a cut grass discharge preventer 43A disposed at a peripheral portion of the area of the rotation of the corresponding blade 5 and configured to prevent cut grass from being discharged. The cut grass discharge preventer 43A for the present embodiment is integral with the rear baffle 42A and disposed at a left portion of the rear baffle 42A.

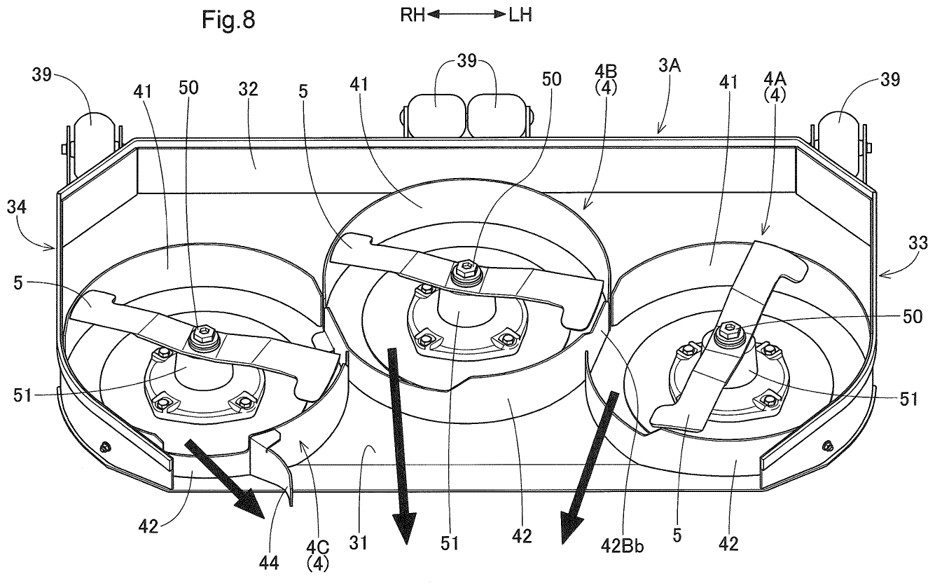

The cut grass discharge preventer 43A has a lower end 43Aa that is below (i) the lower end 42Aa of that portion of the rear baffle 42A at which the cut grass discharge preventer 43A is absent and (ii) the upper end of the corresponding blade 5 (or of its wind generators 5c). The upper end of the rear baffle 42A is apart from the lower end 43Aa of the cut grass discharge preventer 43A by a distance LA3 larger than the distance LA2. The distance LA3 for the present embodiment is larger than the distance LA1. With this configuration, the rear baffle 42A includes a first portion at which the cut grass discharge preventer 43A is present and a second portion at which the cut grass discharge preventer 43A is absent, the first portion extending downward further than the second portion to below the upper end of the corresponding blade 5 (or of its wind generators 5c). Further, the first portion of the rear baffle 42A extends downward to below the lower end 41Aa of the front baffle 41A. The cut grass discharge preventer 43A, which is configured as above, prevents cut grass from being discharged sideways relative to the vehicle. The rear baffle 42A forms thereunder a passage hole through which air flows only in a particular direction as illustrated with the arrows in FIG. 8. This reduces the dispersion of air passing through the passage hole and allows cut grass to be discharged through the passage hole in a particular direction.

As illustrated in FIG. 5, the cut grass discharge preventer 43A for the present embodiment includes at the right end an inclined portion 43Ab having a lower edge so inclined as to be closer to the lower end 42Aa of the rear baffle 42A further rightward.

### Central Subunit

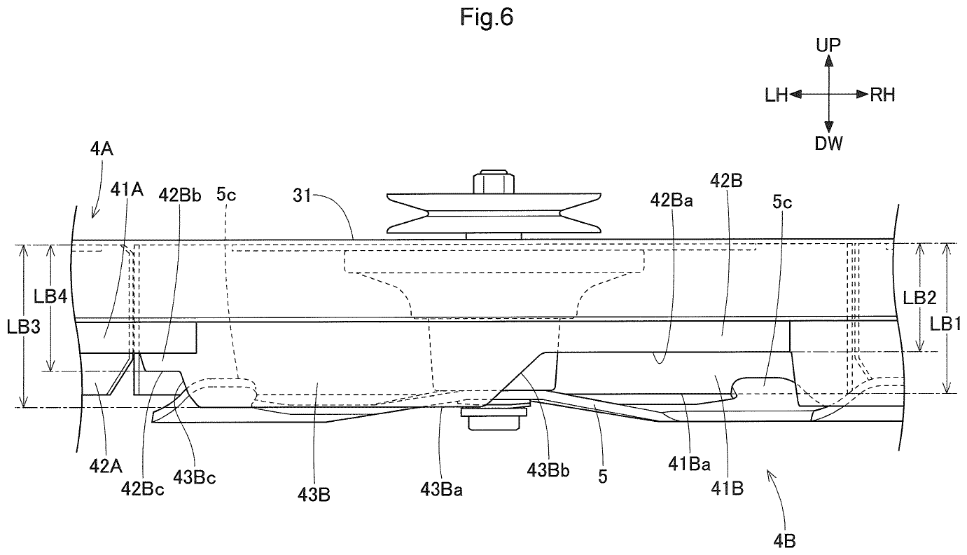

FIG. 6 illustrates the central subunit 4B, which includes a front baffle 41B and a rear baffle 42B. The front baffle 41B extends downward from the top wall 31 to below the upper end of the corresponding blade 5 (or of its wind generators 5c). The front baffle 41B has an upper end joined to the top wall 31 and a lower end 41Ba apart from the upper end by a distance LB1, whereas the rear baffle 42B has an upper end joined to the top wall 31 and a lower end 42Ba apart from the upper end by a distance LB2, the distance LB1 being larger than the distance LB2. The front baffle 41B thus extends downward to have a lower end 41Ba close to the ground surface and thereby prevent cut grass from being discharged from under the lower end 41Ba. The rear baffle 42B, in contrast, extends downward to have a lower end 42Ba that allows cut grass to be discharged from thereunder.

The rear baffle 42B includes a cut grass discharge preventer 43B disposed at a peripheral portion of the area of the rotation of the corresponding blade 5 and configured to prevent cut grass from being discharged. The cut grass discharge preventer 43B for the present embodiment is integral with the rear baffle 42B and disposed at a left portion of the rear baffle 42B.

The rear baffle 42B includes to the left of the cut grass discharge preventer 43B a shared portion 42Bb between respective right end portions of the front and rear baffles 41A and 42A of the left subunit 4A. The shared portion 42Bb is a part of the central subunit 4B and also a part of the left subunit 4A (see FIG. 3).

The cut grass discharge preventer 43B has a lower end 43Ba that is below (i) the lower end 42Ba of that portion of the rear baffle 42B at which the cut grass discharge preventer 43A is absent and (ii) the upper end of the corresponding blade 5 (or of its wind generators 5c). The upper end of the rear baffle 42B is apart from the lower end 43Ba of the cut grass discharge preventer 43B by a distance LB3 larger than the distance LB2. The distance LB3 for the present embodiment is larger than the distance LB1.

The shared portion 42Bb has an upper end joined to the top wall 31 and a lower end 42Bc apart from the upper end by a distance LB4 smaller than the distances LB1 and LB3 and larger than the distance LB2. With this configuration, the rear baffle 42B includes a first portion at which the cut grass discharge preventer 43B is present and a second portion at which the cut grass discharge preventer 43B is absent, the first portion extending downward further than the second portion to below the upper end of the corresponding blade 5 (or of its wind generators 5c). Further, the first portion of the rear baffle 42B extends downward to below the lower end of the front baffle 41B. The cut grass discharge preventer 43B, which is configured as above, prevents cut grass from being discharged sideways relative to the vehicle. The rear baffle 42B forms thereunder a passage hole through which air flows only in a particular direction as illustrated with the arrows in FIG. 8. This reduces the dispersion of air passing through the passage hole and allows cut grass to be discharged through the passage hole in a particular direction.

As illustrated in FIG. 6, the cut grass discharge preventer 43B for the present embodiment includes an inclined portion 43Bb at the right end and an inclined portion 43Bc at the left end. The inclined portion 43Bb has a lower edge so inclined as to be closer to the lower end 42Ba of the rear baffle 42B further rightward. The inclined portion 43Bc has a lower edge so inclined as to be closer to the lower end 42Bc of the shared portion 42Bb further leftward.

### Right Subunit

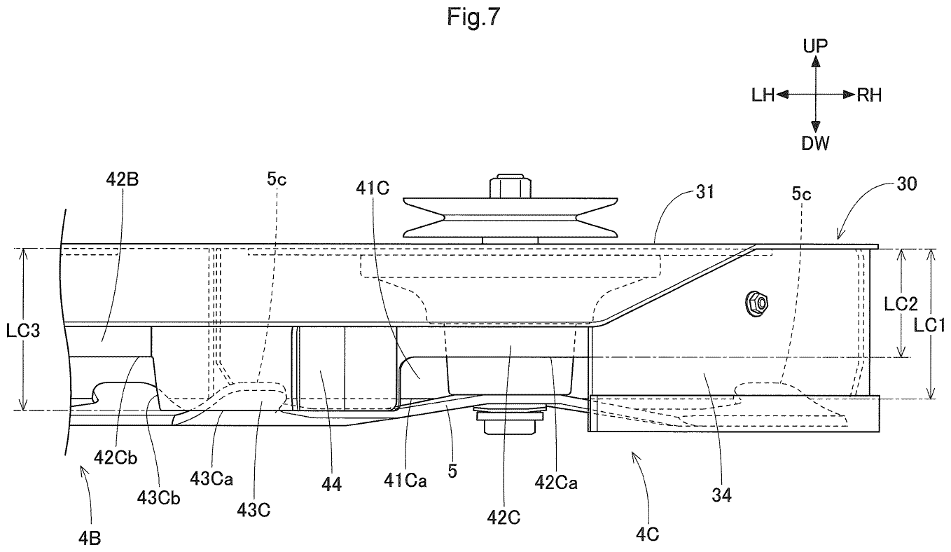

FIG. 7 illustrates the left subunit 4C, which includes a front baffle 41C and a rear baffle 42C. The front baffle 41C extends downward from the top wall 31 to below the upper end of the corresponding blade 5 (or of its wind generators 5c). The front baffle 41C has an upper end joined to the top wall 31 and a lower end 41Ca apart from the upper end by a distance LC1, whereas the rear baffle 42C has an upper end joined to the top wall 31 and a lower end 42Ca apart from the upper end by a distance LC2, the distance LC1 being larger than the distance LC2. The front baffle 41C thus extends downward to have a lower end 41Ca close to the ground surface and thereby prevent cut grass from being discharged from under the lower end 41Ca. The rear baffle 42C, in contrast, extends downward to have a lower end 42Ca that allows cut grass to be discharged from thereunder.

The rear baffle 42C includes a cut grass discharge preventer 43C disposed at a peripheral portion of the area of the rotation of the corresponding blade 5 and configured to prevent cut grass from being discharged. The cut grass discharge preventer 43C for the present embodiment is integral with the rear baffle 42C and disposed at a left portion of the rear baffle 42C.

The cut grass discharge preventer 43C has a lower end 43Ca that is below (i) the lower end 42Ca of that portion of the rear baffle 42C at which the cut grass discharge preventer 43C is absent and (ii) the upper end of the corresponding blade 5 (or of its wind generators 5c). The upper end of the rear baffle 42C is apart from the lower end 43Ca of the cut grass discharge preventer 43C by a distance LC3 larger than the distance LC2. The distance LC3 for the present embodiment is larger than the distance LC1. With this configuration, the rear baffle 42C includes a first portion at which the cut grass discharge preventer 43C is present and a second portion at which the cut grass discharge preventer 43C is absent, the first portion extending downward further than the second portion to below the upper end of the corresponding blade 5 (or of its wind generators 5c). Further, the first portion of the rear baffle 42C extends downward to below the lower end of the front baffle 41C. The cut grass discharge preventer 43C, which is configured as above, prevents cut grass from being discharged sideways relative to the vehicle. The rear baffle 42C forms thereunder a passage hole through which air flows only in a particular direction as illustrated with the arrows in FIG. 8. This reduces the dispersion of air passing through the passage hole and allows cut grass to be discharged through the passage hole in a particular direction.

As illustrated in FIG. 7, the cut grass discharge preventer 43C for the present embodiment includes an inclined portion 43Cb at the left end. The rear baffle 42C includes to the left of the cut grass discharge preventer 43C a left portion 42Cb having an upper end joined to the top wall 31 and a lower end apart from the upper end by a distance equal to the distance LC2. The inclined portion 43Cb has a lower edge so inclined as to be closer to the lower end of the left portion 42Cb further leftward.

The rear baffle 42B of the central subunit 4B has a right portion between respective left end portions of the front and rear baffles 41C and 42C. The right portion is a part of the central subunit 4B and also a part of the right subunit 4C (see FIG. 3).

As illustrated in FIGS. 3 and 7, the left subunit 4C for the present embodiment includes a guide 44 extending rearward from a right end portion of the cut grass discharge preventer 43C. Specifically, the guide 44 extends from a right end portion of the cut grass discharge preventer 43C obliquely in a leftward and rearward direction, and is so bent as to have a rear end portion extending rearward. This configuration allows cut grass discharged from the space to the right of the cut grass discharge preventer 43C to be guided by the guide 44 and a rear end portion of the right wall 34 of the housing 30 toward the lateral center.

The present embodiment is configured to share an equal value between the distance LA1 for the front baffle 41A of the left subunit 4A, the distance LB1 for the front baffle 41B of the central subunit 4B, and the distance LC1 for the front baffle 41C of the right subunit 4C. The distances LA1, LB1, and LC1 may alternatively differ from one another. The present embodiment is configured to share an equal value between the distance LA2 for the rear baffle 42A of the left subunit 4A, the distance LB2 for the rear baffle 42B of the central subunit 4B, and the distance LC2 for the rear baffle 42C of the right subunit 4C. The distances LA2, LB2, and LC2 may alternatively differ from one another. The present embodiment is configured to share an equal value between the distance LA3 for the rear baffle 42A and the cut grass discharge preventer 43A of the left subunit 4A, the distance LB3 for the rear baffle 42B and the cut grass discharge preventer 43B of the central subunit 4B, and the distance LC3 for the rear baffle 42C and the cut grass discharge preventer 43C of the right subunit 4C. The distances LA3, LB3, and LC3 may alternatively differ from one another.

### Alternative Embodiments

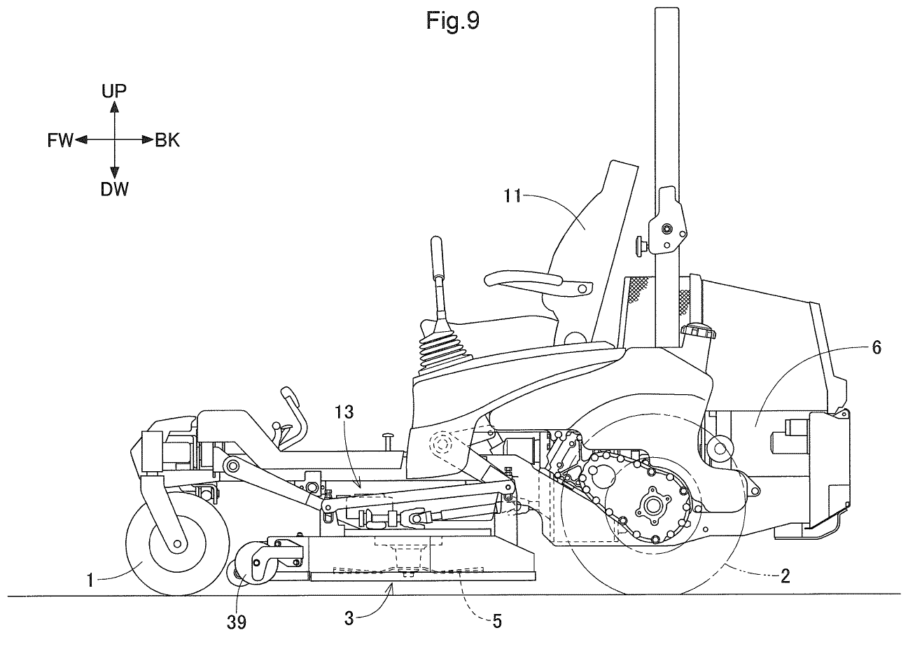

The description below deals with example alternatives to the embodiment described above.
(1) The embodiment described above is an example in which the distance LA3 for the rear baffle 42A and the cut grass discharge preventer 43A is larger than the distance LA1 for the front baffle 41A of the left subunit 4A. The present invention is, however, not limited to such an embodiment. The distance LA1 may be equal to the distance LA3, or may be larger than the distance LA2 for the rear baffle 42A of the left subunit 4A and smaller than the distance LA3. Similarly, the distance LB1 for the front baffle 41B of the central subunit 4B may be equal to the distance LB3 for the rear baffle 42B and the cut grass discharge preventer 43B. The distance LB3 may be larger than the distance LB2 (or LB4) from the upper end of the rear baffle 42B to its lower end 42Ba and smaller than the distance LB1. Further, the distance LC1 for the front baffle 41C of the right subunit 4C may be equal to the distance LC3 for the rear baffle 42C and the cut grass discharge preventer 43C. The distance LC3 may be larger than the distance LC2 from the upper end of the rear baffle 42C to its lower end 42Ca and smaller than the distance LC1.
(2) The embodiment described above is an example in which the cut grass discharge preventer 43A includes an inclined portion 43Ab. The present invention is, however, not limited to such an embodiment. The cut grass discharge preventer 43A may omit the inclined portion 43Ab. Similarly, the cut grass discharge preventer 43B may omit the inclined portions 43Bb and 43Bc. Further, the cut grass discharge preventer 43C may omit the inclined portion 43Cb.
(3) The embodiment described above is an example in which the mower is a front mount mower with a mower device 3 forward of the mower body. The present invention is, however, not limited to such an embodiment. The mower may alternatively be a zero-turn mower with a mower device 3 under a central portion of the mower body as illustrated in FIG. 9. The mower may further alternatively include, instead of the engine 6, an electric motor configured to drive the front wheels 1 and the mower device 3.

The arrangements disclosed for the above embodiments (including the alternative embodiments; hereinafter the same applies) may each be combined with an arrangement disclosed for another embodiment, as long as such a combination does not cause a contradiction. Further, the embodiments disclosed in the present specification are mere examples. The present invention is not limited to those embodiments, and may be altered as appropriate, as long as such an alteration does not result in a failure to attain an object of the present invention.

1. A mower deck mountable on a vehicle,
the mower deck comprising:
a housing including a top wall;
a blade disposed below the top wall and rotatable through an area about a vertical axis and
a baffle unit extending downward from the top wall and surrounding the area to define inside a blade rotation space for mulching,
the baffle unit including:
a front baffle facing a forward-travel side of the vehicle and extending downward from the top wall to have a lower end below an upper end of the blade to prevent cut grass from being discharged from under the lower end; and
a rear baffle facing a rearward-travel side of the vehicle and extending downward from the top wall to a vertical position that allows cut grass to be discharged from under a lower end of the rear baffle,
the rear baffle including a cut grass discharge preventer disposed at a peripheral portion of the area and configured to prevent cut grass from being discharged.

2. The mower deck according to claim 1, wherein
the cut grass discharge preventer is configured to prevent cut grass from being discharged sideways relative to the vehicle.

3. The mower deck according to claim 1, wherein
the cut grass discharge preventer is integral with the rear baffle.

4. The mower deck according to claim 3, wherein
the rear baffle includes a first portion at which the cut grass discharge preventer is present and a second portion at which the cut grass discharge preventer is absent, the first portion extending downward further than the second portion to below the upper end of the blade.

5. The mower deck according to claim 4, wherein
the second portion has a lower end above the upper end of the blade.

6. The mower deck according to claim 5, wherein
the blade includes an end portion bent upward as a wind generator, and
the first portion has a lower end below an upper end of the wind generator.

7. The mower deck according to claim 6, wherein
the second portion has a lower end above the upper end of the wind generator.

8. The mower deck according to claim 1, wherein
the first portion extends downward to below a lower end of the front baffle.

9. A mower, comprising:
a vehicle; and
a mower deck according to claim 1.
